(19) United States
(12) Patent Application Publication
(10) Pub. No.: US 2007/0184316 A1
(43) Pub. Date: Aug. 9, 2007

(54) FUEL CELL ELECTRICITY MEASURING METHOD AND APPARATUS

(76) Inventor: CHUN-CHIN TUNG, Chupei (TW)

Correspondence Address: G. LINK CO., LTD., 3550 BELL ROAD, MINOOKA, IL, 60447, US

(21) Appl. No.: 11/670,331

(22) Filed: Feb. 1, 2007

(30) Foreign Application Priority Data
Feb. 8, 2006 (TW) 095104178

(51) Int. Cl. H01M 8/04

(52) U.S. Cl. 429/23

(57) ABSTRACT

A fuel cell electricity measuring apparatus is disclosed. The apparatus comprises a fuel cell and a measuring unit. The measuring unit comprises an electricity measuring device configured to measure a cumulative amount of an electricity amount output by the fuel cell and a processing device configured to calculate and obtain a remaining electricity amount information according to the cumulative amount measured by the electricity measuring device. The fuel cell is electronically connected to the measuring unit.

### FIELD OF THE INVENTION

The present invention relates to a fuel cell electricity measuring method and apparatus, utilizing a measuring unit to measure a fuel concentration or remaining electricity amount of a fuel cell.

### BACKGROUND OF THE INVENTION

Conventional fuel cells generally include cell cores utilizing hydrogen-rich fuels (such as methyl alcohol) and oxygen-rich fuels to perform chemical response and generate electricity. In application of compact size fuel cells, a user is in need to be acknowledged when the fuel concentration is low or the fuel volume is not enough and requires supply. As a result, there is need to measure the fuel surface height or fuel volume in a fuel tank of the fuel cells. Generally, a fuel tank utilizes expensive measurement sensors to identify the fuel concentration or fuel volume, which is not economic in consideration of the mass usage in the portable electronic products.

Due to the defects in the conventional fuel identifying method of a fuel cell and the apparatus to perform the method, the inventor eagerly performs research to obtain an identification method or mechanism for the fuel concentration or fuel volume and the corresponding electricity amount or power supplying time.

### SUMMARY OF THE INVENTION

Accordingly, an objective of the invention is to provide a fuel cell electricity measuring method and apparatus in order to measure a fuel concentration of the remaining fuel of a fuel cell.

Alternatively, another objective of the invention is to provide a fuel cell electricity measuring method and apparatus in order to measure a remaining electricity amount of a fuel cell.

Alternatively, another objective of the invention is to provide electricity measuring method and apparatus in order to measure a usage time of the remaining electricity amount of a fuel cell.

To realize the above-mentioned objectives, the invention discloses a fuel cell electricity measuring method and apparatus. The apparatus comprises a fuel cell and a measuring unit. The measuring unit comprises an electricity measuring device and a processing device. The electricity measuring device is configured to measure a cumulative amount of an electricity amount output by the fuel cell, and the processing device is configured to calculate and obtain a remaining electricity amount information according to the cumulative amount measured by the electricity measuring device. The fuel cell is electronically connected to the measuring unit.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is an illustrative view of an embodiment of a fuel cell electricity measuring apparatus of the invention;

FIG. 2 is an illustrative view of an embodiment of the circuit of the fuel cell electricity measuring apparatus of the invention; and

FIG. 3 is a flow chart of an embodiment of a fuel cell electricity measuring method of the invention.

### DETAILED DESCRIPTION OF THE INVENTION

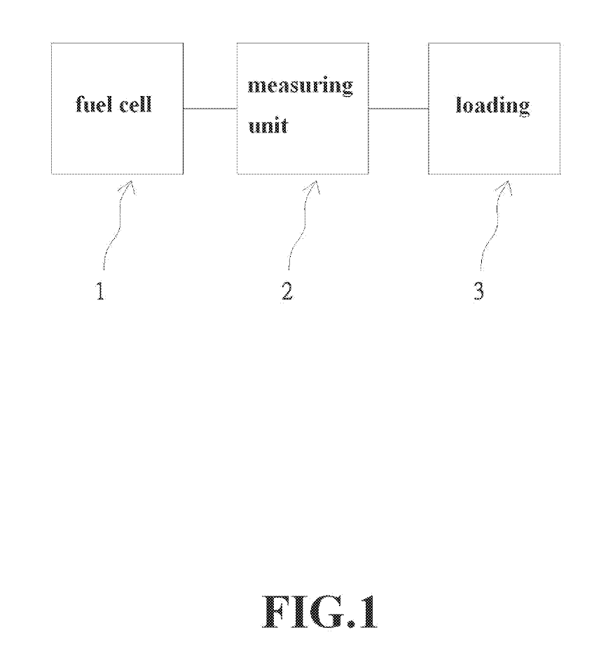

FIG. 1 illustrates elements of an embodiment of a fuel cell electricity measuring apparatus of the invention. The apparatus of the embodiment comprises a fuel cell 1 electronically connected to a measuring unit 2 such that the output electricity of the fuel cell 1 is transmitted to a loading 3 through the measuring unit 2 to supply power required for the loading 3. The fuel cell 1 is an energy transforming device, which comprises catalyst substances and performs electrochemical response with hydrogen-rich fuel and oxygen-rich fuel to transform chemical energy to electrical energy for output. The loading 3 is a device using electricity power for operation, e.g. an electronic device such as a laptop computer or a PDA.

The measuring unit 2 comprises an electricity measuring device and a processing device. The electricity measuring device is configured to measure a cumulative amount of an electricity amount output by the fuel cell 1 to the loading 3. For example, the electricity measuring device can be utilized to measure current value output by the fuel cell 1 to the loading 3. The processing device is configured to calculate a cumulative current value measured by the electricity measuring device, and calculate a total electricity power output of the fuel cell 1 and obtain other related information. For example, the related information may comprise a remaining electricity amount information of the fuel cell 1, a fuel cell remaining usage time information of the fuel cell 1, or a fuel concentration of the fuel cell 1.

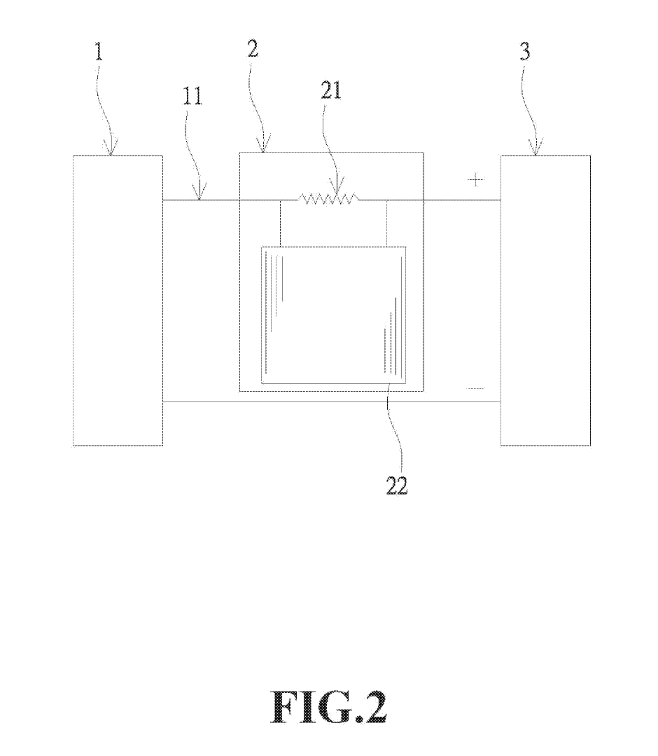

FIG. 2 illustrates the circuit in an embodiment of the fuel cell electricity measuring apparatus of the invention. In the above-mentioned apparatus, the fuel cell 1 comprises an electricity transmitting wire 11 for outputting electric power generated, and the measuring unit 2 comprises a resistance element 21 and a processor 22. The resistance element 21 is electronically series connected to the electricity transmitting wire 11 of fuel cell 1, and the processor 22 comprises a wire to be parallel connected to the resistance element 21 such that the processor 22 measure a voltage drop of the resistance element 21 via the wire parallel connecting the resistance element 21. Since the resistance element 21 has a predetermined resistance, a current value of the resistance element 21 can be calculated, which equals to the current value output by the fuel cell 1, thus realizing the electricity measuring device. In addition, the processor 22 may further comprise a circuit device to realize the processing device, which is configured to calculate the cumulative current value measured by the resistance element 21, calculate the total electricity power output of the fuel cell 1, and obtain a fuel concentration information of the fuel cell 1 according to the total electricity power output.

The above-mentioned processor 22 may comprise a processing chip, a memory chip and electronic connection wires, forming a reasonable circuit to realize the processing device.

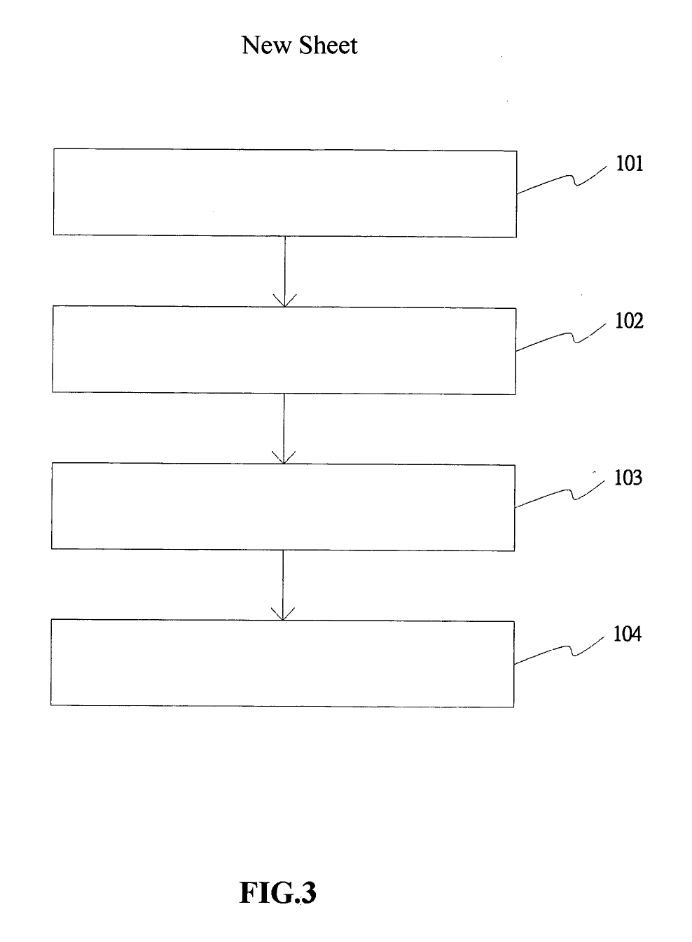

FIG. 3 illustrates a flow chart of an embodiment of the fuel cell electricity measuring method of the invention. Referring to the apparatus in FIG. 2, the method comprises that: in step 101: statistic numbers according to experiments of the fuel cell 1 are provided, and corresponding information between the total electricity power output and the remaining fuel concentration information is recorded and stored in the processor 22 of the processing unit 2. Step 102: the output current of the fuel cell 1 flows through the resistance element 21 of the processing unit 2, and the electricity measuring device obtains the current value output. Step 103: the processing device of the processor 22 of the processing unit 2 calculates the cumulative current value measured by the resistance element 21, and calculates the total electricity power output of the fuel cell 1. Step 104: according to the total electricity power output and the corresponding information between the total electricity power output and the remaining fuel concentration, the processing device obtains a corresponding remaining fuel concentration.

In the above-mentioned process, the remaining fuel concentration information is an optional output information. The processing device may estimate the electricity amount generated from the remaining fuel with further calculation. Alternatively, estimation of the electricity amount generated from the remaining fuel can be realized according to the statistic numbers obtained in experiments of the fuel cell 1, and corresponding information between the total electricity power output and the electricity amount generated from the remaining fuel information can be stored in the processing device. Thus, the processing device may obtain a corresponding electricity amount generated according to the total electricity power measured by the electricity measuring device.

Furthermore, the method to obtain the remaining fuel concentration according to the total electricity power output can be realized in an alternative way according to the relation between the electricity amount in the electrochemical response of the fuel cell 1 and the responsive substances. Specifically, the electricity amount in the electrochemical response of the fuel cell 1 is in proportional to the mole number of the responsive substances. As a result, a fuel consumption amount in the response can be calculated according to the corresponding electricity amount to the total electricity power measured by the electricity measuring device, and the remaining fuel amount can be calculated by subtraction of the original fuel amount and the fuel consumption amount. In addition, the remaining fuel amount can be utilized by calculation of the processing device to obtain the electricity amount generated by the remaining fuel.

By calculation of the total electricity power measured by the electricity measuring device, the processing unit may obtain the electricity amount generated by the remaining fuel. Further calculation may generate a fuel cell remaining usage time for the loading 3 to maintain operation.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A fuel cell electricity measuring apparatus, comprising:
a fuel cell; and
a measuring unit, comprising an electricity measuring device configured to measure a cumulative amount of an electricity amount output by the fuel cell and a processing device configured to calculate and obtain a remaining electricity amount information according to the cumulative amount measured by the electricity measuring device;
wherein the fuel cell is electronically connected to the measuring unit.

2. The fuel cell electricity measuring apparatus as claimed in claim 1, wherein the remaining electricity amount information obtained by the processing device according to the cumulative amount is a fuel cell remaining usage time information.

3. The fuel cell electricity measuring apparatus as claimed in claim 2, wherein the processing device obtains the remaining electricity amount information according to the cumulative amount and corresponding remaining electricity amount information.

4. The fuel cell electricity measuring apparatus as claimed in claim 1, wherein the electricity measuring device measures a current value output by the fuel cell, and the processing device calculates a cumulative current value and obtain the remaining electricity amount information according to the cumulative current value.

5. The fuel cell electricity measuring apparatus as claimed in claim 4, wherein the processing device obtains a remaining fuel amount of the fuel cell according to the cumulative current value.

6. The fuel cell electricity measuring apparatus as claimed in claim 5, wherein the processing device obtains a fuel concentration of the fuel cell according to the remaining fuel amount of the fuel cell.

7. The fuel cell electricity measuring apparatus as claimed in claim 5, wherein the processing device obtains the remaining electricity amount information according to the remaining fuel amount of the fuel cell.

8. The fuel cell electricity measuring apparatus as claimed in claim 4, wherein the measuring unit comprises a resistance element and a processor to form the electricity measuring device, the resistance element is electronically series connected to the fuel cell, and the processor comprises a voltage drop measuring device configured to measure a voltage drop of the resistance element and measures the current value of the resistance element to obtain the current value output by the fuel cell.

9. The fuel cell electricity measuring apparatus as claimed in claim 1, wherein the processing device comprises corresponding information of the electricity amount and the remaining electricity amount information such that the processing device calculates and obtains the remaining electricity amount information according to the electricity amount.

10. The fuel cell electricity measuring apparatus as claimed in claim 9, wherein the remaining electricity amount information is selected from a group of a fuel cell remaining usage time information and a remaining fuel amount of the fuel cell.

11. A fuel cell electricity measuring apparatus, comprising:
a fuel cell; and
a measuring unit, comprising an electricity measuring device configured to measure a cumulative amount of electricity amount output by the fuel cell and a processing device configured to calculate and obtain a fuel concentration information of the fuel cell according to the electricity amount measured by the electricity measuring device;
wherein the fuel cell is electronically connected to the measuring unit.

12. The fuel cell electricity measuring apparatus as claimed in claim 11, wherein the processing device obtains the fuel concentration information of the fuel cell according to the cumulative amount and corresponding remaining electricity amount information.

13. The fuel cell electricity measuring apparatus as claimed in claim 11, wherein the electricity measuring device measures a current value output by the fuel cell, and the processing device calculates a cumulative current value of the resistance element and obtain the remaining electricity amount information according to the cumulative current value.

14. The fuel cell electricity measuring apparatus as claimed in claim 11, wherein the measuring unit comprises the resistance element and a processor to form the electricity measuring device, the resistance element is electronically series connected to the fuel cell, and the processor comprises a voltage drop measuring device configured to measure a voltage drop of the resistance element and measures the current value of the resistance element to obtain the current value output by the fuel cell.

15. The fuel cell electricity measuring apparatus as claimed in claim 11, wherein the processing device comprises corresponding information of the electricity amount and the fuel concentration information of the fuel cell such that the processing device calculates and obtains the fuel concentration information of the fuel cell according to the electricity amount.
